(19) United States
(12) Patent Application Publication
(10) Pub. No.: US 2009/0037340 A1
(43) Pub. Date: Feb. 5, 2009

(54) Digital certification method and apparatus

(75) Inventors: Stephen M. Hitchen, Lynwood (GB); Susan E. Morrow, Lynwood (GB); James A.L. Porter, Swanage (GB); Gerard D. O'Brien, Richmond (GB)

Correspondence Address: BROWN RUDNICK LLP, ONE FINANCIAL CENTER, BOSTON, MA, 02111, US

(73) Assignee: Avoco Secure, London (GB)

(21) Appl. No.: 11/881,849

(22) Filed: Jul. 30, 2007

(51) Int. Cl. H04L 9/00

(52) U.S. Cl. 705/76

(57) ABSTRACT

A document is recorded with authenticity certification information by receiving an indication that a client is prepared to indicate acceptance and/or receipt of a proposed set of documentary content elements. A visual display of the documentary content elements is presented. An actuatable acknowledgment mechanism and a field for receipt of account information is presented. The actuation of said actuatable acknowledgment mechanism is detected and the account information is transmitted to an account provider. Asymmetric key pairs from one or more items associated with the account are generated. A digital certificate derived from one or more items associated with the account is generated.

### TECHNICAL FIELD

The invention relates to methods for certifying the authenticity of documents utilizing a multipurpose certification database and optionally associated hardware.

### BACKGROUND OF THE INVENTION

Today, digital signatures are established as an authentication vehicle in numerous applications. They may function as a means of showing that an electronic document has not been changed. Likewise, digital signatures may prove that a particular document existed at a particular time or that an individual agreed to the document content.

Currently, the use of a digital signature carries with it the requirement for the signer to possess an individual digital certificate. While existing methods employing digital signatures function as intended, they are of limited value on account of the small number of individuals having digital certificates and the relatively cumbersome infrastructural implementations needed to generate them.

### SUMMARY OF THE INVENTION

In accordance with the invention, a method of document signing and authentication is provided. The inventive method has the advantage of minimal implementation costs on account of its using existing components in a system which may be implemented on largely existing personal computer and network infrastructure. The inventive system finds implementation in numerous contexts, including the authenticated transfer of information for consent, information receipt and agreement transactions, as well as controlled document access.

The inventive system is well suited to use in electronic documents in many applications which, in the nondigital world, would require the equivalent of a signature, for example signing of consent forms, agreements, and other documents that are currently still largely paper-based.

The invention is in contrast to existing techniques which rely upon the transfer of forms which are manually signed and then digitized. The use of digitized images is clumsy, requiring substantial data transfer times and storage space. Moreover, images are of increasingly dubious reliability, given that ease with which commonly available computers, software and associated equipment allow any wrongdoer to capture and edit images.

In contrast, the relatively higher security of a digital signature is provided in accordance with the method of the present invention. Moreover, in accordance with the invention, verification and document handling is seamless in the context of modern data handling systems. At the same time, the inventive system provides for a means of electronic validation of a signature at multiple locations and at multiple times.

Digital signatures are an established technology and a number of international standards exist that describe standardized protocols and signature formats. Adherence to these standards facilitates exchange of digitally signed electronic documents so that a recipient may expect the digital signature to be verifiable through use of existing methods and systems. Although the invention described does not require the signer to possess a digital certificate, the claimed invention can be applied to produce digital signatures to any protocol and in any standard format, making integration with existing digital signature verification systems straight-forward.

The invention also includes a method for generating asymmetric and symmetric encryption and digital signature keys from personal data.

In accordance with the inventive method, a document is recorded with authenticity certification information, comprising receiving an indication that a client is prepared to indicate acceptance and/or receipt of a proposed set of documentary content elements. A visual display of the documentary content elements is presented. An actuatable acknowledgment mechanism is presented. A field for receipt of account information is also presented. The actuation of the actuatable acknowledgment mechanism is detected. The account information is transmitted to an account provider. Asymmetric key pairs from one or more items associated with said account are generated. The items may be selected from the group consisting of date, time, information sent to said account provider, information received from said account provider, information sent to a certified timestamp operator and information received from a certified timestamp operator. A digital certificate from one or more items associated with the account is generated.

The document may be a contract evidencing an offer and an acceptance.

The actuation of said actuatable mechanism may result in transmitting account information, including a charge to a debit, credit or similar account operator.

The method may be implemented online over the Internet, off-line via the telephone, or off-line at a retail bricks and mortar establishment.

The process may be confirmed by sending documentary content elements together with a visual representation of a signature to the client.

The signature may also be embedded in electronic documents sent to the client. The generated digital certificate may be used to digitally sign electronic documents.

### BRIEF DESCRIPTION THE DRAWINGS

The operation of the invention will become apparent from the following description taken in conjunction with the drawings, in which:

FIG. 1 is a flow chart generally illustrating a general implementation of the present invention;

FIG. 2 is a block diagram illustrating an exemplary embodiment of the method as implemented according to the present invention in a hospital consent system;

FIG. 3 illustrates an embodiment of the present invention in the context of a merchant sales agreement;

FIG. 4 is a block diagram illustrating an exemplary embodiment of a verification method as implemented according to the present invention;

FIG. 5 illustrates an alternative embodiment of the present invention in the context of a bricks and mortar merchant sales system;

FIG. 6 illustrates the inventive method in the context of communication with a bank;

FIG. 7 illustrates use of an encrypted document; and

FIG. 8 illustrates an alternative embodiment of a merchant sales agreement method.

### DETAILED DESCRIPTION OF THE PREFERRED EMBODIMENTS

Most people possess one or more accounts, such as a credit or debit card account, the details of which are unique to that person. In accordance with the invention, a person's existing account is utilized as an identification of its owner in a digital identity verification process, or digital signature. This is achieved in the context of document authentication using the unique details of, by way of example, a credit card. The result of the method of the invention is thus to provide a more universally accessible and lower cost means of signing electronic documents, which is more easily usable as a substitute for at least some relatively cumbersome and expensive paper document-based business procedures.

Thus, in accordance with the present invention, means are provided for furnishing a low-assurance identity for digital signatures. In accordance with a particularly preferred embodiment of the invention, credit card or debit card, for example, data is used to generate, on-the-fly, a conventional digital certificate which is used for digital signing. The certificate is destroyed after signing to remove the need for storage.

Moreover, it is contemplated that the inventive method may be implemented either online or offline, in various ways as will be detailed below.

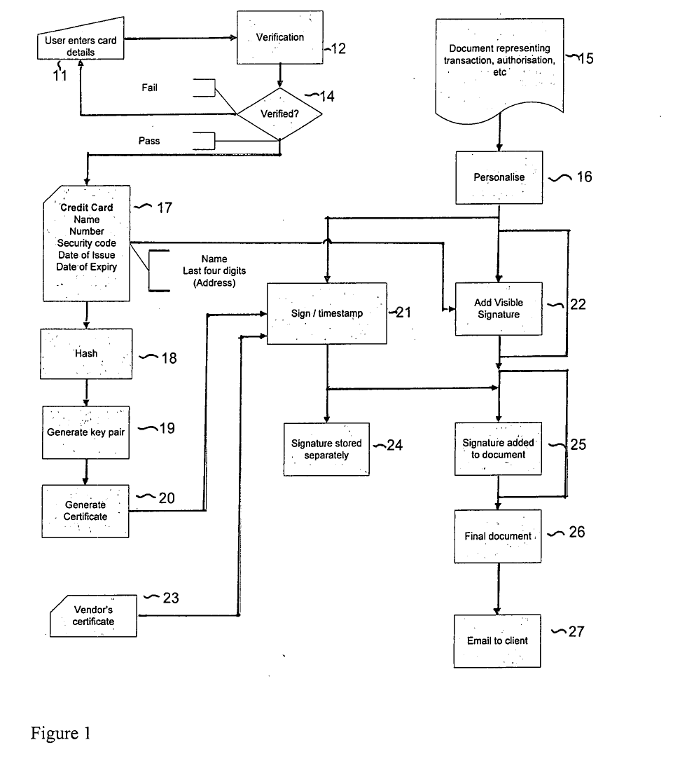

Referring to FIG. 1, an embodiment of the inventive method 10 for signing with credit card data in accordance with the invention is provided. In accordance with the embodiment of method 10, the operator of the system, which may be any entity requiring an authenticated document (such as an entity making a contract, seeking a consent, requiring an authenticated transfer of information and so forth) may have a conventional digital certificate. In addition, the client with whom the operator is dealing (such as, respectively, the client with whom a contract is being made, the client whose consent is sought, or the client to whom information is being sent) is required to have a credit card or other similar account or other mechanism.

At the beginning of the verification method 10 illustrated in FIG. 1, the user enters a verification information at step 11. The data input at step 11 may consist of the sixteen digit account number typical of modern credit card systems, together with an expiration date and verification numbers, as well as the name of the card issuer, such as Visa, MasterCard, Discover or American Express. Typically, this would be done at a personal computer connected, for example, to the Internet. If verification is not made at step 12, this is noted at step 14, and the user is given the opportunity to reenter verification data by the system returning to step 11.

In accordance with the present invention, such verification data, once authenticated at step 14, may be input into the system at step 16.

In accordance with method 10, the operator of the system requires some means of validating the client's credit card information. The mechanics of this validation will depend on the nature of the transaction involved. For example, if the service involves a transfer of funds, the transaction requires such validation separate and apart from the authentication involved. Accordingly, such verification may be accessed at step 12, either for the first time with the credit card issuer, or by reference to a database showing previous verifications associated with the same transaction where the card has already been used and validated.

Once the card is validated, a document to be signed (such as a contract of sale specifying return policies, performance characteristics or the like; an acknowledgment of the receipt of a set of instructions for a potentially dangerous device being sold; a product warning; or the like) can be electronically generated at step 15 by the system operator. Such document generation may involve the personalization of an existing template document with information specific to the client at step 16. Document generation may be facilitated in whole or in part by the use of client information associated with the credit card.

When the document has been generated, the document with the embedded visible signature is presented at step 16 to the client for signature, for example by presentation of the screen showing the document and card number, name, address, expiration date and card issuer, and presenting an “I Agree” hyperlink or icon. When the icon is clicked upon, some or all of the card details entered in step 11 are input to a secure hash algorithm (“SHA”), such as SHA-1, at step 18 to derive binary data of some fixed length according to the hashing algorithm used.

A secure hash algorithm or SHA refers to a number of functions that share a common basis, all of which produce a fixed size, unique, digital fingerprint from digital data. The difference between the different SHA algorithms is the size of the fingerprint produced, with a larger sizes increasing the probability that the fingerprint (or ‘hash’) will be unique for a given input data. The version of SHA used in current digital certificates and signing is SHA-1 which produces a fingerprint of 160 bits. Such algorithms weren't designed by the U.S. National Security Agency (NSA) and published by NIST as a U.S. Government standard. It is described in RFC 4634 (http://tools.ietf.org/html/rfc4634)

In accordance with the present invention this hash, as a representation of the card details, is used to seed a pseudo-random number generator to generate the prime numbers that form the basis for a key pair for a digital signing algorithm in step 19. For example, if signing is to use the common RSA algorithm the pseudo random number generator is used to create the primes p and q used as the basis of the keys for this algorithm. The key pair is then used to create the digital certificate in step 20.

RSA is an algorithm for public key cryptography. It is the most common algorithm used for digital signing and RSA keys are normally the ones associated with digital certificates. It is described in PKCS#1 by RSA Labs (http://www.rsa.com/rsalabs/node.asp?id=2125.)

It should be noted that, because the pseudo random number generator is seeded from the representation of the card details, then the same key pair will be generated whenever the same card details are used. This affords a method of generating personal digital certificates on-the-fly, for signing and encryption, with consistent keys, without the inherent problems of storage and transportation normally associated with digital certificates. In effect a user would have the ability to regenerate their card-based digital certificate and produce conventional digital signatures regardless of their location.

Key pairs for algorithms other than RSA (e.g., elliptic curve) could also be generated from the hash of the card details to further extend the application of the invention.

The scheme could also be extended to the generation of symmetrical keys (e.g., for DES and AES algorithms) from the card data for encryption and message authentication codes (MAC).

DES is an older US Government encryption standard algorithm for symmetric encryption. Although still used in some established processes, it has largely been superseded by AES (Advanced Encryption Standard). See http://csrc.nist.gov/publications/fips/fips46-3/fips46-3.pdf.

AES is a widely used symmetric encryption algorithm that has been adopted as a standard in many countries. It is described in U.S. FIPS PUB 197.

An MAC (Message Authentication Code) is a small sequence of binary data used to check the integrity of data, for example, to detect if the data has been altered in transmission or storage. Different protocols exist for calculating MACs.

In accordance with the present invention the generated digital certificate will incorporate the name of the user and the last four digits of the card in the displayable fields of the certificate, to facilitate identification of the card used.

A visible representation of a signature may optionally be incorporated into the document at step 22. The visible signature may include such things as the last four digits of the sixteen digit credit card number. Alternatively (or in addition), the card holder's name and address, obtained, for example, from the card may be placed in a visible signature field.

The generated certificate is then used to sign the document from step 22 in step 21. The signature will incorporate the generated certificate to facilitate later verification of the signature.

To increase the non-repudiation element of the signature the signature may be time stamped by sending a hash of the signature or document to a certified time-stamp provider who will digitally sign the hash along with the current date and time from a reliable time source and return the signed information as a time stamp as described in RFC 3161. The time stamp can be used to prove the time of the signature and hence use of the card details, and is incorporated into the signature in step 21.

RFCs (Request For Comments) are lists of protocol standards maintained by IETF (Internet Engineering Task Force). See http://www.ietf.org/home.html. RFC 3161 refers to the standard for time stamping request to a time stamping authority. RFC 2898 is the same as PKCS#5—a protocol for deriving symmetric encryption keys from passwords or other data. The substance of the recited protocols and standards are incorporated herein by reference.

To further strengthen the signature, it may also be countersigned by the vendor's digital certificate if this is available from the system in step 23.

The completed digital signature may be stored separate from the document optionally, for example, in a database in step 24. More conveniently, the signature may be stored in the document itself in step 25, to produce the final document in step 26.

Following generation and use of the RSA key pair and digital certificate both would be destroyed, storage being unnecessary.

In accordance with the invention, a document may be subjected to an authentication operation by reading and/or re-creating the data input and verifying the digital signature by conventional means.

In accordance with the present invention, it is contemplated that either the document itself, or an image of the document presented at step 26 and including the indication of the actuation of the “I accept” icon would be sent by e-mail to the client for his records.

As alluded to above, it is contemplated that in accordance with the present invention, the name of the client, his credit card number, credit card type, security code, date of issue, date of expiration, and or other data may be gathered over the telephone to allow use of the subject inventive authentication and signature verification system in off-line applications. It is noted that, in this specification, reference to authentication means to include signature verification, document authentication, agreement indication, and other similar functions, and that any one of these implementations, when illustrated by a particular example, may be implemented in that particular example, as generally taught herein.

As can be seen from the above, the credit card hash, card last four digits, user name and address and other information may be added as signature attributes (i.e. those which are included in the signature) may be used to facilitate electronic verification of the document. Other information which may be included with the signature may include a document description or identification number to facilitate searching and indexing, and for providing a record which may be used for various purposes. The same is of particular value if the signature is stored separately from the document. Such separate storage would facilitate rapid searching and verification with respect to documents, where the person making the inquiry has only limited or only paper information, for example, during an initial inquiry.

As will be understood from the above, method 10 may be used either on-line or off-line. In either case only the system operator would require installation of software. The software required for off-line use is substantially identical to that required for online use, except that online use requires the additional installation of software for interfacing with input from the client, for example, over the Internet.

Conversely, off-line usage require the system operator to install client function implementing software components to allow the input of client generated information into the system as it is received, for example, over the telephone from the client, or at a keyboard and screen at the premises of, for example, a merchant.

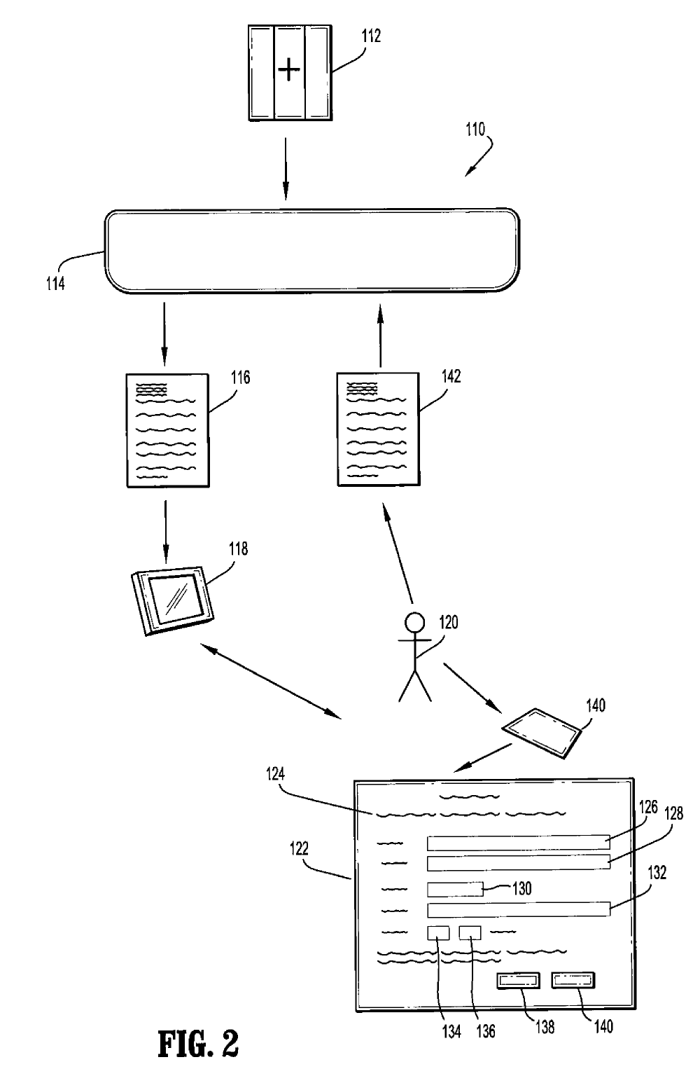

An implementation of a method in accordance with the present invention, as illustrated in FIG. 1, is illustrated in FIG. 2. In this implementation, a method 110 is provided for authenticated documentation of a patient consent given to a hospital 112. Hospital 112 has a document system 114 which is used to generate documents, such as a blank operation consent form 116, which is input into a liquid crystal display screen 118 for presentation to a patient 120 in the hospital receiving room or a doctor's office.

In particular, a form 122, including consent agreement terms 124, typically consisting of a number of paragraphs, a field 126 for the entry of the name of the client, a field 128 for the entry of the address of the client, a field 130 for the selection of the credit card issuer, a field 132 for the entry of the sixteen digit credit card number, a field 134 for the entry of a card expiration date, a field 136 for the entry of the year of expiration of the credit card, an icon 138 for the indication of agreement, as well as an icon 140 for a declination of agreement.

Document 122 is presented to client 120 on screen 18. In this example, client 120 is located in a hospital and is at, perhaps, a special word processing station consisting of a keyboard and screen dedicated to the subject task or part of a multitasking station. Client 120 enters the data, much of it from the client's credit card, for example a Visa credit card 140. Upon the clicking of the “I agree” icon 138, the card details are used to generate a digital certificate and this is used to digitally sign the document 122. Optionally the signature is time stamped and countersigned, The signed, authorized version 142 of document 122 is sent to the hospital's document system 114 for storage.

Optionally, if there has been a credit or debit card charge associated with the transaction, and substantially simultaneous with the consent, digital certificate data associated with the charge may be encrypted in the document before it is stored in the document management system 114 of the hospital.

Thus, the hospital's document management portal may serve as an input and database for document authentication and the verification functions.

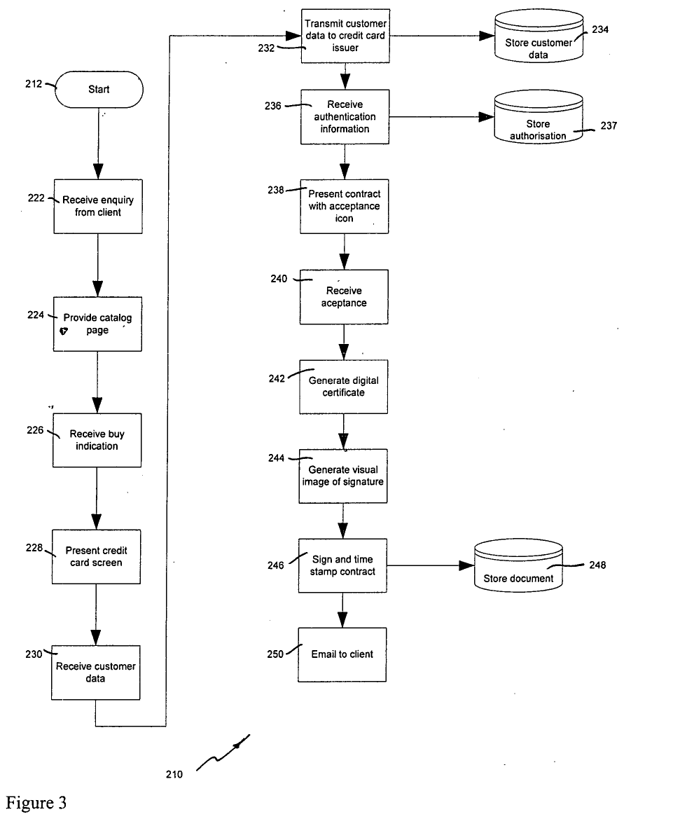

Referring to FIG. 3, the implementation of the invention, in the context of a purchase where the terms of purchase are to be signed by a user in order to form an agreement, is illustrated. The same is achieved in accordance with the steps of a method 210, as will be described in detail below.

More particularly, in accordance with the present invention, the method of the present invention is implemented through the use of a website of the type typically used for the transaction of business over the Internet. The implementation of the method 210 of the present invention begins with the activation of the website at step 212. Upon receipt of an inquiry from a client at step 222, in a conventional manner, the client is provided with various catalog pages and opportunities to purchase goods at step 224. Upon the indication of a desire to purchase, perhaps by clicking and “add to shopping cart” icon at step 226, the customer is provided with an input screen at step 228 to receive customer data at step 230.

As an alternative to filling in the contents of screen 228, the customer may have a card reader associated with the customer's computer and may simply swipe the card to fill in the fields in the form presented on the input screen at step 228.

Regardless of how the customer data is obtained, this customer data is provided to a credit card issuer at step 232. At the same time, the customer data may be stored at step 234, for later use as will be described in detail below.

At step 236 the credit card issuer sends an electronic message authorizing the charge and indicating his acceptance. This information is stored at step 237. At step 238, a contract screen displaying the terms of the contract and an acceptance of icon is sent to the customer. Upon the clicking of the “I accept” icon, the acceptance is transmitted to the system operator at step 240. The system operator generates a digital certificate from the card data at step 242. The system, at step 244, then generates a visual image of the signature of the containing the customer name and last four digits of their card number and places this is in the contract. The system operator uses the generated certificate it to sign the contract with times tamping of the signature at step 246.

The signed contract is stored in step 248 and a copy of the contract is emailed optionally to the client in step 250.

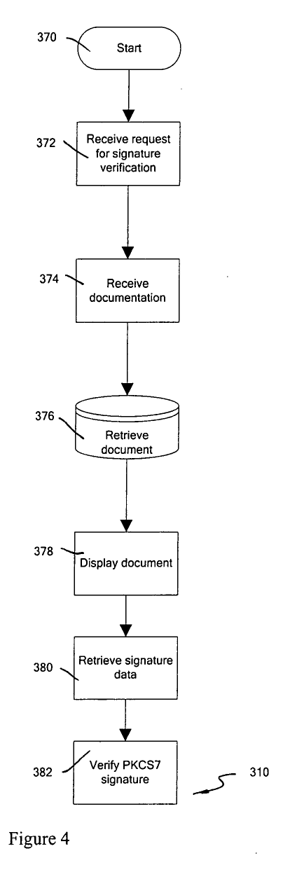

Referring to FIG. 4, a verification method 310 is illustrated. Verification begins at step 370 with the receipt at step 372 of a request for signature verification. Upon the receipt of such a request, the document is retrieved at step 376 and displayed to the individual making the inquiry at step 378.

The system then retrieves the digital signature from the document and verifies both the signature and the timestamp in steps 380 and 382, respectively.

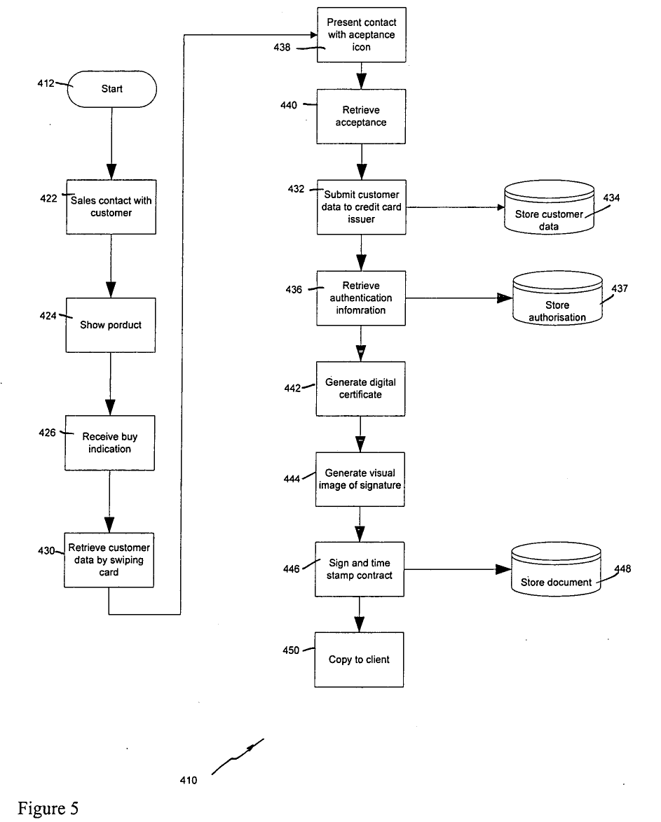

Referring to FIG. 5, a method similar to that illustrated in FIG. 3 is illustrated. However, method 410 illustrated in FIG. 5 is dedicated to implementation of the inventive method in a bricks and mortar context, for example at a retail location operated by a merchant. In the embodiment illustrated in FIG. 5, steps performing corresponding or analogous functions have been given numbers 200 higher than the numbers associated with those steps in the embodiment of FIG. 3.

Generally, method 410 begins at step 412 with the receipt of a customer in the bricks and mortar retail location. At step 422 contact is made with the customer. At step 424 the customer is shown product.

At step 426, the customer gives an indication that he or she wishes to buy a product to the sales clerk. Following this the sales clerk swipes the credit or debit card of the customer. The customer is then presented with a contract, for example on the screen of a personal computer at step 438. The screen also includes the terms of the contract and/or any other information which the merchant wishes the customer to accept and agree to. Such acceptance is done by clicking on a suitable icon at step 440.

At step 432 data generated by the card swipe is transmitted to the credit card issuer. That information is stored at step 434. A return data stream is then received at step 436 and stored at step 437. A digital certificate is generated from the card details in step 442. A visual signature is inserted in the contract at step 444 and the digital signature from step 442 is used to sign the contract which is also time stamped at this step 446. The signed contract is stored in step 448 and a copy of the signed contract given to the client in step 450.

A further extension of this invention is the generation of symmetrical keys for encryption. In this scheme, an encryption key (for example an AES or DES key) is derived from the credit card data using a method such as that described as PKCS#5 (RFC 2898), or inputting the card data to a simple hashing algorithm, the output of which can be used directly or re-hashed or otherwise transformed, or inputting the card data into a pseudo random number generator. In any of these cases the card data is one-way transformed to binary data which is then used as an encryption key, avoiding the direct use of the card data as the key which would lead to insecurities. The derived key is then used to encrypt a document or message intended only to be decrypted an authorized card user. The recipient of the message or document uses their credit card to regenerate the encryption key and decrypts the message.

This scheme could be used by banks and other card issuers for secure communication with their customers. The document or message from the bank would be encrypted using the scheme described above and on receipt by the customer, could be decrypted and read. Similarly the document could be edited by the customer (for example, an electronic form filled in), encrypted using the above scheme and sent back to the bank where it would be decrypted using the customer's card details. Using this scheme and storage of credit card details on mobile devices such as cell phones would, in conjunction with encryption/decryption software on the device, facilitate secure messaging between the bank and the customer via their mobile device.

Note that the digital certificate and corresponding asymmetric key pair generated from card details as referred to earlier in this invention may also be used for encryption applications, using established an established public key encryption cipher such as RSA.

The inventions for both signing documents using digital certificates derived from card data and encrypting documents using symmetric or asymmetric keys derived from card data can be combined to produce signed and encrypted documents.

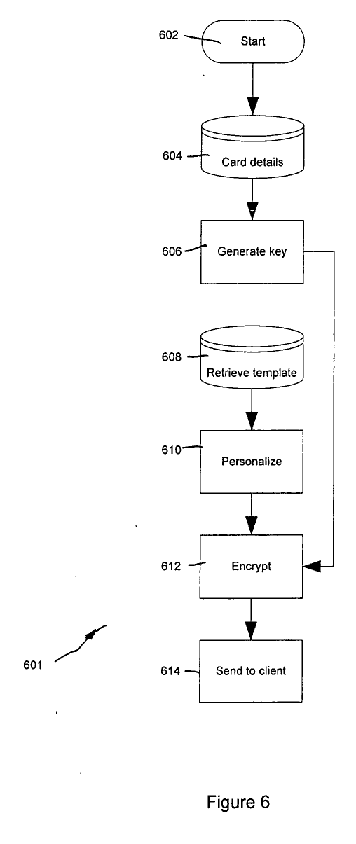

An implementation of a method in accordance with the present invention is shown in FIG. 6 which illustrates method 601, used by a bank for secure communication with a client, for example a mortgage agreement form.

The method starts at step 602 with the bank retrieving the client's card details from its database in step 604 and uses them according to this invention to generate a 256 bit AES symmetric encryption key by taking some of the card details and hashing them in step 606. A template document is taken from a database in step 608 is personalized for the client in step 610 and then encrypted in step 612 with the key generated in step 606. The key is then discarded securely. The encrypted document is sent to the client by email in step 614.

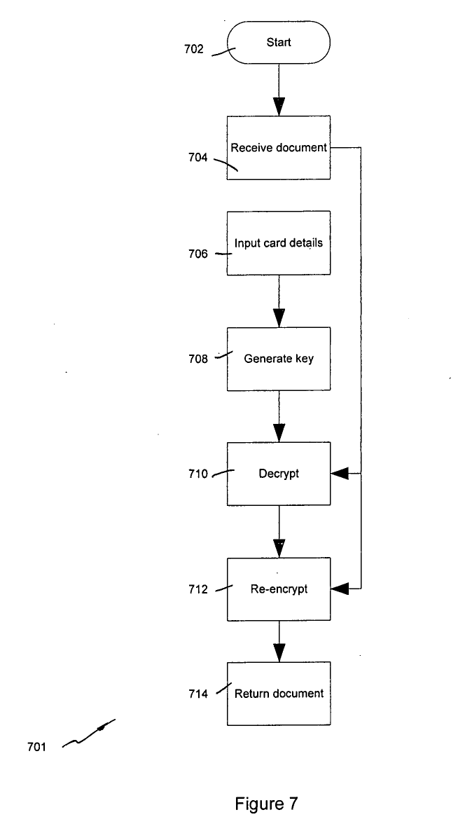

FIG. 7 illustrates method 701 showing how a document encrypted according to method 601 can be used by the Bank's client. The method starts at step 702 with the client receiving the document by email in step 704. The client inputs their card details into a program that generates the key required to decrypt the document in steps 706-708. Alternatively a hardware card swiping device could be programmed to carry out these steps. The key is then used to decrypt the document in step 710 allowing the client to read and edit it. If the document is to be filled in and returned to the Bank it is re-encrypted with the key generated earlier and sent back to the Bank in steps 712-714.

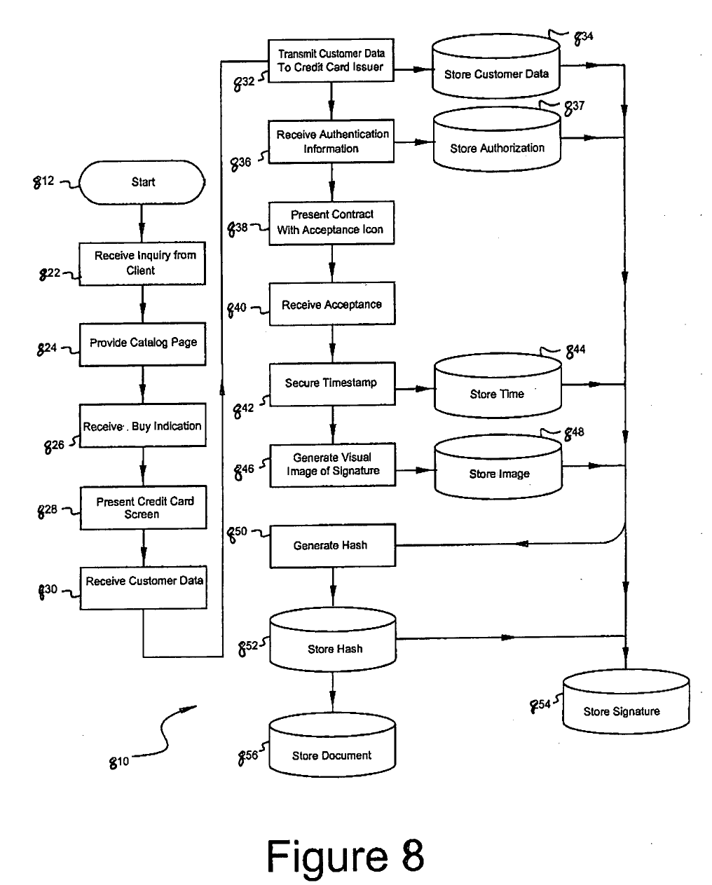

Referring to FIG. 8, the implementation of the invention, in the context of a purchase where the terms of purchase are to be signed by a user in order to form an agreement, is illustrated. The same is achieved in accordance with the steps of method 810, as will be described in detail below.

More particularly, in accordance with the present invention, the method of the present invention is implemented through the use of a website of the type typically used for the transaction of business over the Internet. The implementation of the method 810 of the present invention begins with the activation of the website at step 812. Upon receipt of an inquiry from a client at step 822, in a conventional manner, the client is provided with various catalog pages and opportunities to purchase goods at step 824. Upon the indication of a desire to purchase, perhaps by clicking an “add to shopping cart” icon at step 826, the customer is provided with an input screen at step 828 to receive customer data at step 830.

As an alternative to filling in the contents of screen 828, the customer may have a card reader associated with the customer's computer and may simply swipe the card to fill in the fields in the form presented on the input screen at step 828.

Regardless of how the customer data is obtained, this customer data is provided to a credit card issuer at step 832. At the same time, the customer data may be stored at step 834, for later use as will be described in detail below.

At step 836 the credit card issuer sends an electronic message authorizing the charge and indicating his acceptance. This information is stored at step 837. At step 838, a contract screen displaying the terms of the contract and an acceptance of icon is sent to the customer. Upon the clicking of the “I accept” icon, the acceptance is transmitted to the system operator at step 840. The system operator than secures a timestamp from a certified timestamp provider at step 842. The time information is then stored at step 844 together with timestamp provider information which accompanied the same. The system, at step 846 then generates a visual image of the signature of the customer and the same is stored at step 848.

The system then receives the data stored at steps 834, 837, 844 and 848 at step 850 where a hash is generated, as described above in connection with the previous embodiments. The hash is stored at step 852 and, together with the data stored at steps 834, 837, 844 and 848 is stored at step 854. Optionally, the signature data stored at step 854 may be encrypted when the agreement document is stored at 856. Optionally, an image of the agreement document with the visual representation of a signature generated at 846 may be sent to the customer for his records.

What is claimed:

1. A method for recording a document with authenticity certification information, comprising:
(a) receiving an indication that a client is prepared to indicate acceptance and/or receipt of a proposed set of documentary content elements;
(b) presenting a visual display of said documentary content elements;
(c) presenting an actuatable acknowledgment mechanism;
(d) receiving account information;
(e) detecting the actuation of said actuatable acknowledgment mechanism;
(f) transmitting said account information to an account provider;
(g) generating asymmetric key pairs from one or more items associated with said account; and
(h) generating a digital certificate from one or more items associated with said account.

2. A method as in claim 1, wherein the document is a contract evidencing an offer and an acceptance.

3. A method as in claim 1, wherein said items selected from the group consisting of date, time, information sent to said account provider, information received from said account provider, information sent to a certified timestamp operator and information received from a certified timestamp operator.

4. A method as in claim 1, wherein said actuation of said actuatable mechanism results in transmitting account information, including a charge to a debit, credit or similar account operator.

5. A method as in claim 1, wherein said method is implemented online over the Internet.

6. A method as in claim 1, wherein said method is implemented off-line via the telephone.

7. A method as in claim 1, wherein said method is implemented off-line at a retail bricks and mortar establishment.

8. A method as in claim 1, wherein said documentary content elements together with a visual representation of a signature are sent to the client.

9. A method as in claim 1, wherein said signature is embedded in electronic documents sent to the client.

10. A method as in claim 1 wherein a generated digital certificate is used to digitally sign electronic documents.

11. A method generating symmetric encryption keys from one or more items associated with said account.

12. A method for recording a document with authenticity certification information, comprising:
(a) receiving an indication that a client is prepared to indicate acceptance and/or receipt of a proposed set of documentary content elements;
(b) presenting a visual display of said documentary content elements;
(c) presenting an actuatable acknowledgment mechanism;
(d) presenting a means for receipt of account information;
(e) detecting the actuation of said actuatable acknowledgment mechanism;
(f) transmitting said account information to an account provider;
(g) generating asymmetric key pairs from one or more items associated with said account
(h) generating a digital certificate from one or more items associated with said account
(i) retrieving said hash and said items;
(j) regenerating a hash from said items using the same algorithm to create a regenerated hash;
(k) comparing said regenerated hash to said retrieved hash; and
(l) presenting an indication of verification of said regenerated hash and said retrieved hash are the same.
